(19) United States
(12) Patent Application Publication
(10) Pub. No.: US 2006/0069880 A1
(43) Pub. Date: Mar. 30, 2006

(54) Apparatus for controlling access, by processing devices, to memories in an embedded system

(76) Inventors: Carsten Mielenz, Landsberg (DE); Hans-Georg Gruber, Munich (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 11/235,463

(22) Filed: Sep. 26, 2005

(30) Foreign Application Priority Data
Sep. 24, 2004 (DE) DE 10 2004 046 43

(51) Int. Cl. G06F 12/00

(52) U.S. Cl. 711/149; 711/165

(57) ABSTRACT

The present invention provides an apparatus for controlling access, by processing devices to memories in an embedded system, with the apparatus being arranged between the processing devices and the memories, and with the apparatus independently moving data between the memories and between the memories and internal memories in the processing devices.

### CROSS-REFERENCE TO RELATED APPLICATIONS

This application claims foreign priority benefits under 35 U.S.C. §119 to co-pending German patent application number DE 10 2004 046 438.3, filed 24 Sep. 2004. This related patent application is herein incorporated by reference in its entirety.

### BACKGROUND OF THE INVENTION

1. Field of the Invention

The present invention relates, in general, to embedded systems and, in particular, to an apparatus for controlling access, by processing devices, to memories in an embedded system.

2. Description of the Related Art

Embedded systems are frequently used in special applications. For example, they are used in controlling traffic control systems, industrial processes, aircraft, anti-lock braking systems, airbags, dishwashers and washing machines, heaters, ticket machines, medical diagnostic devices, microwave ovens, video recorders, printers, telephones, mobile radios, personal digital assistants (PDAs), handhelds, smartphones or other portable devices.

An embedded system is often a small and compact computer system which has a processing device and memories and to which various peripherals, for example sensors or actuators, can be connected. However, relatively large peripherals, such as hard-disk drives, are frequently not connected. Embedded systems are usually capable of communicating with other systems. Since the complexity of the tasks of embedded systems is increasing, an operating system is also being used more frequently.

In embedded systems, the processing devices are, for example, central processing units (CPUs), digital signal processors (DSPs), microcontroller units (MCUs) or direct memory access (DMA) data transmission devices. In addition to internal memories which are provided in the processing devices, external memories are also used as memories. For reasons including cost and operation, the external memories are larger than the internal memories and are often non-volatile memories which are used to store important data. The external memories are, for example, synchronous dynamic random access memories (SDRAMs), NAND flash memories, NOR flash memories, DDR (double data rate) memories, magnetic random access memories (MRAMs), cellular random access memories (CRAMs) and video random access memories (VRAMs) etc.

In the case of operating systems, such as Symbian or WinCE, which are used for embedded systems, the kernel status for example, is buffer-stored in non-volatile external memories. Operating systems having a known source code (OpenOS), for example Linux, likewise require data to be buffer-stored in external non-volatile memories. Applications or programs which are in the form of firmware, and data are generally stored in the external memories. All embedded systems have a “start-up code” which is run after the system has been switched on. This start-up code normally deactivates the interrupts, calibrates the internal electronics, tests the processing devices and the firmware and starts applications, for example programs, which have been programmed for use of the embedded system. One or more processing devices access the applications via one or more external memories using a memory controller. Reliability, i.e. reliability against failure and fault tolerance, and security, i.e. protection against external attacks, for example, is playing an increasingly greater role in embedded systems. Therefore security devices for protection against access violations, when the memories are being accessed, are frequently provided in a memory controller.

The advantages of embedded systems reside, in particular, in the small size and in the optimum matching of their individual components to one another. If non-volatile memories are used, it is possible to update programs, for example the firmware, without having to change a chip.

FIG. 2 shows one known memory system. The memory system 1 is connected to a plurality of processing devices 2 and 3 having internal memories (not shown). The processing devices are, for example, central processing units, microcontroller units, digital signal processors, DMA data transmission devices and generally modules which are capable of functioning as the master and they can be entitled to independently access memories. The memory system 1 has a memory controller 4 and a plurality of memories 5, 6 and 7. The processing devices 2 and 3 are connected, via respective ports 8 and 9, to the memory controller 4 for the purpose of interchanging data and applying addresses. The addresses are assigned to, and specify, positions in the memories of the plurality of memories 5, 6 and 7. The memory controller 4 is connected, via connections 10, 11 and 12, to the memories 5, 6 and 7 likewise for the purpose of interchanging data and applying addresses. The memories 5, 6 and 7 are subdivided into any desired areas 13, 14 and 15 and are, for example, SDRAM, NAND flash, NOR flash, DDR, MRAM, CRAM or VRAM memories. The memory controller 4 has a security device 16.

The processing devices 2 and 3 are used, inter alia, to execute applications and process data stored in the memories 5, 6 and 7. The memory controller 4 controls access, by the processing devices 2 and 3, to data and applications in the memories 5, 6 and 7. The security device 16 is used to protect against access violations when the memories 5, 6 and 7 are being accessed. To this end, access rights which depend on a respective port of the plurality of ports 8 and 9, on the access address and on the type of access, for example reading or writing, are assigned to the areas 13, 14 and 15. In this case, for example, only reading may be permitted at the port 8 when addressing the area 13 in the memory 5, writing and reading may be permitted when addressing the area 14 in the memory 5, while access may not be permitted when addressing all of the areas 13, 14 and 15 in the memory 6. Only reading may be permitted at the port 9, for example, when addressing the area 15 in the memory 5, reading and writing may be permitted when addressing the area 13 in the memory 5, and access may not be permitted when addressing all of the areas 13, 14 and 15 in the memory 6.

FIG. 3 shows another known memory system 1 and a known memory controller 4. The memory controller 4 has only one port 8 for connecting to a processing device 2. In comparison to FIG. 2, the memory controller 4 also has a multiplexer 17. The multiplexer 17 is connected to the port 8 of the memory controller 4 and, as a function of an address at the port 8, connects the latter to one of the memories of the plurality of memories 5, 6 and 7.

FIG. 4 shows another known memory system 1 and another known memory controller 4. The memory controller 4 has a plurality of ports 8 and 9 for connecting to a plurality of processing devices 2 and 3. In comparison to FIG. 3, the memory controller 4 also has an arbitration device 18, which is connected to the plurality of ports 8 and 9 of the memory controller 4 and is connected to the multiplexer 17 via a connection 19. The multiplexer 17 is preferably connected to the memories of the plurality of memories 5, 6 and 7 via the security device 16 and the connections 10, 11 and 12. The arbitration device 18 individually connects the ports of the plurality of ports 8 and 9 to the input of the multiplexer 17 as a function of the importance or priority of a port or of the processing device connected to the port. The priority of a port is determined, for example, using known arbitration algorithms. As in FIG. 3, the multiplexer 17 connects a respective port to one of the memories 5, 6 and 7 as a function of the address at the respective port of the plurality of ports 8 and 9 of the memory controller 4.

In the known memory systems, a respective processing device of the plurality of processing devices 2 and 3 reads data and programs from, and writes them to different positions when placing data in a memory 5, 6 and 7. For example, in order to copy data from the memory 5 to the memory 6, a processing device needs to read the data from a position in the memory 5, buffer-store it in an internal memory in said processing device and write it to a position in the memory 6 or store it at a position in the memory 6 that differs from the position from which the data has been read. Data and program safeguarding (housekeeping), for example writing contents in an internal volatile memory to a non-volatile memory or buffer-storing (caching) data in memory systems, is effected by moving/copying data/programs from the memory 6 to the memory 5, for example, in a synchronized or non-synchronized manner. When moving/copying data/programs in a synchronized manner, moving/copying is controlled for example by a clock. In contrast, when moving/copying data/programs in a non-synchronized or asynchronous manner, said moving/copying is initiated, for example, by specific non-synchronized events, such as the powering-down of the embedded system. Therefore, Moving or copying from one memory to another is generally carried out as a function of an event or events which may be synchronized or non-synchronized.

One disadvantage of the known memory systems is that, under the control of a respective processing device, data must always be moved from the outside, for example, from an external memory, to the inside (read transaction), i.e. to an internal memory of a processing device, and back to the outside (write transaction) to an external memory or vice versa. This is complicated, and the data is also moved in the process via buses, for example, which may constitute a security problem.

### SUMMARY OF THE INVENTION

The object of the present invention is to provide an apparatus for controlling access, by processing devices, to memories in an embedded system. The apparatus makes it possible to move data between the memories in an efficient and secure manner.

The idea on which the present invention is based is to provide a memory controller between processing devices and memories in a memory system, wherein the memory controller makes it possible to independently move data between the memories and from the memories to internal memories in the processing devices or vice versa and to safeguard data and programs without using other programmable resources, for example buses for transporting data and processing devices.

The invention provides an apparatus for controlling access, by processing devices, to memories in an embedded system, with the apparatus being arranged between the processing devices and the memories, and with the apparatus independently moving data between the memories and between the memories and internal memories in the processing devices.

One advantage of the present invention is that data is independently moved between memories in a memory system and between memories in a memory system and internal memories in processing devices and vice versa without intervention by other programmable resources, such as processing devices. Data and programs associated with operating systems can be safeguarded (housekeeping) without any other programmable resources, for example processing devices.

Another advantage of the present invention is that the memory controller independently moves data, and that rapid task changes and synchronization are possible. This gives rise to faster speed and better performance of the processing devices (since their load is reduced) and thus of the embedded system and to greater security with respect to manipulation when transporting data, since the latter is not moved via buses but rather within the memory controller.

Another advantage of the present invention is that the operating system for the embedded system does not have to monitor and check movements of data etc. and its load is thus reduced. The operating system is merely informed of whether data has been moved.

Another advantage of the present invention is that the expenditure on programmable resources has been reduced and the memory system can be reused and updated in an improved manner since there is no need for any programs or drivers (which are stored in the internal memories in the processing devices) in order to control the movements of data.

Another advantage of the present invention is that delay times when moving data are minimized.

According to one preferred development of the apparatus, the apparatus moves data between the memories without using the processing devices.

According to another preferred development of the apparatus, the apparatus moves data between the memories without using the internal memories in the processing devices.

According to another preferred development of the apparatus, the apparatus has a programmable control device which moves data between the memories and between the memories and internal memories in the processing devices.

According to another preferred development of the apparatus, the control device is controlled using an initiation signal in order to initiate the movement of data.

According to another preferred development of the apparatus, the control device is controlled using a control signal, which indicates asynchronous events, in order to control the movement of data.

According to another preferred development of the apparatus, the apparatus has a security device for protecting against access violations when the memories are being accessed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a memory system having a memory controller according to the invention for an embedded system;

FIG. 2 shows one known memory system;

FIG. 3 shows another known memory system; and

FIG. 4 shows another known memory system.

### DETAILED DESCRIPTION OF THE PREFERRED EMBODIMENT

In the figures, identical reference symbols denote identical or functionally identical components.

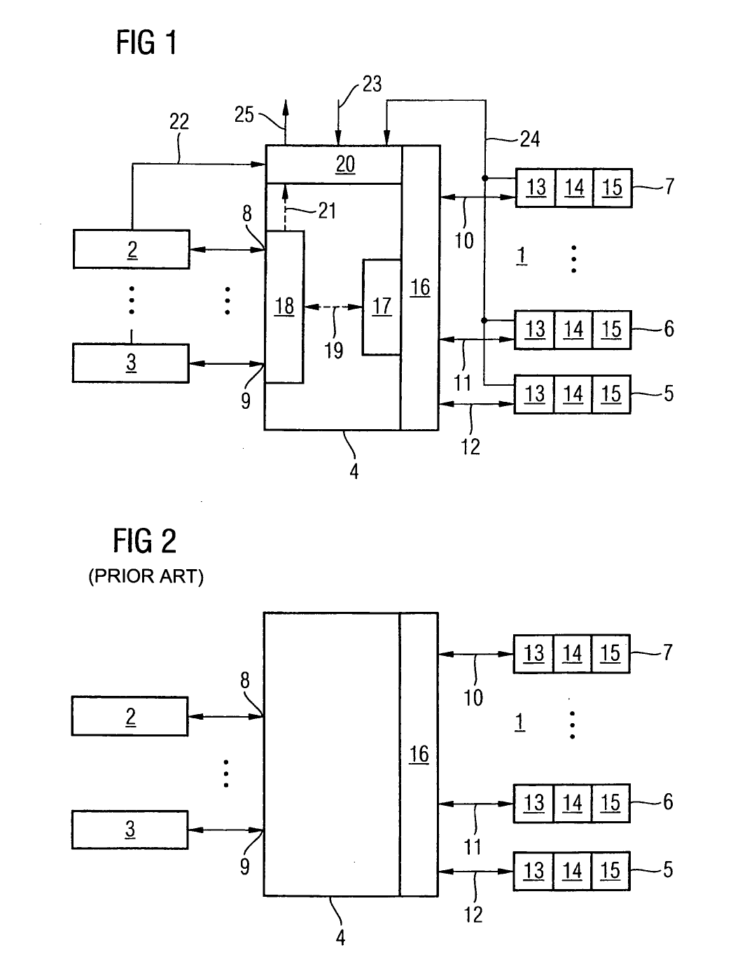

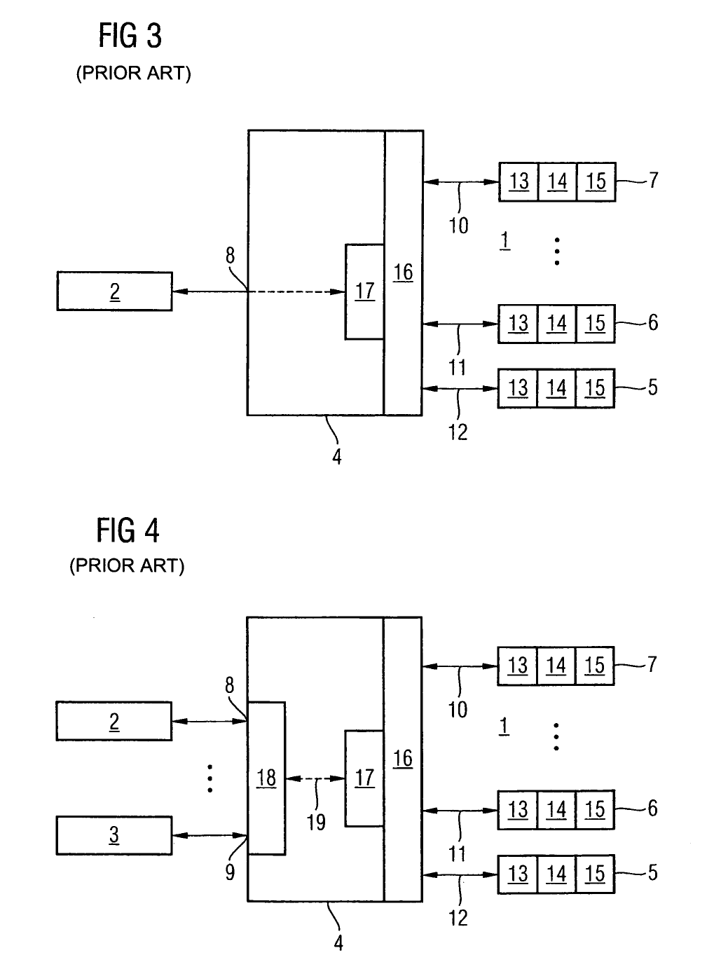

FIG. 1 shows a memory system having a memory controller according to the invention for an embedded system. The memory system 1 has the memory controller 4 and a plurality of memories 5, 6 and 7, which are connected via connections 10, 11 and 12 to the memory controller 4 for the purpose of interchanging data and applying addresses. The addresses are assigned to and specify positions in the memories of the plurality of memories 5, 6 and 7. The memory controller 4 also has ports 8 and 9, to which a plurality of processing devices 2 and 3 are connected for the purpose of interchanging data and applying addresses. The data processing devices have internal memories for storing, processing and buffer-storing data. The memories of the plurality of memories 5, 6 and 7 are each subdivided into an associated arbitrary plurality of areas 13, 14 and 15 having arbitrary sizes. The memory controller 4 also has a security device 16, a multiplexer 17, an arbitration device 18 and a control device 20. The ports 8 and 9 of the memory controller 4 are connected to the arbitration device 18 in the memory controller 4. The arbitration device 18 in the memory controller 4 is connected to the multiplexer 17 via a connection 19. The multiplexer 17 is preferably connected to the memories of the plurality of memories 5, 6 and 7 via the security device 16 and the connections 10, 11 and 12. The arbitration device 18 generates a first programming signal 21. The control device 20 is programmed and controlled using the first programming signal 21, a second programming signal 22, an initiation signal 23 and a control signal 24 and generates a notification signal 25. The processing devices 2 and 3 are preferably central processing units, digital signal processors, microcontroller units and DMA data transmission devices and they are generally modules which are capable of functioning as the master and they may independently access memories. The memories of the plurality of memories 5, 6 and 7 are preferably SDRAM, NAND flash, NOR flash, DDR, MRAM, CRAM or VRAM memories.

The processing devices 2 and 3 are used, inter alia, to execute applications and process data stored in the memories 5, 6 and 7. The memory controller 4 controls access to data and applications in the memories 5, 6 and 7 and independently controls the movement of data and applications between the memories 5, 6 and 7 and between the memories 5, 6 and 7 and internal memories in the processing devices 2 and 3. The arbitration device 18 in the memory controller 4 connects the individual ports of the plurality of ports 8 and 9 to an input of the multiplexer 17 as a function of the importance or priority of a port or of the processing device connected to the port. The priority of a port is determined, for example, using known arbitration algorithms. The multiplexer 17 connects a respective port of the plurality of ports 8 and 9 of the memory controller 4 to one of the memories 5, 6 and 7 as a function of the address at that port. The security device 16 controls access to the areas 13, 14 and 15 in the individual memories of the plurality of memories 5, 6 and 7 and is used to protect against access violations when the memories 5, 6 and 7 are being accessed. To this end, access rights which depend on a respective port of the plurality of ports 8 and 9, on the access address and on the type of access, for example reading or writing, are assigned to the areas 13, 14 and 15.

The control device 20 is controlled using a control program. The arbitration device 18 programs the control device 20 using the first programming signal 21, and the control program is set up. To this end, the control device 20 preferably has a programmable software interface. The second programming signal 22 is generated by a respective processing device 2 and 3 and is used to set rules within the control program for the control device 20, with the control device 20 independently moving data in a controlled manner in accordance with said rules. Such rules determine, for example, the timing of the data movements. The control device 20 is controlled or initiated by an application or a program itself or by external events or memory access operations within the memory controller 4 (access signatures), using the initiation signal 23, in order to carry out data movement actions, such as the safeguarding of data. The control signal 24 is provided by a respective memory 5, 6 and 7 and is used, for example, to indicate asynchronous events, such as the powering-down of an embedded system, and to appropriately control the program sequence in the control device 20, in order to interrupt or terminate movements of data. The notification signal 25 informs an embedded system that data has been moved.

The control device 20 automatically and independently processes movements of data independently of the processing devices 2 and 3, and automatic and independent data and program safeguarding functions are used for interchanging data. The memory controller 4 thus independently moves data between the memories 5, 6 and 7 and between the memories 5, 6 and 7 and internal memories in the processing devices, for example, without using the processing devices 2 and 3.

The memory controller 4 is preferably a memory controller for SDRAM memories or flash memories having a control device 20 which has a functionality similar to that of a DMA data transmission device and transmits data over DMA data channels.

Although the present invention was described above using a preferred exemplary embodiment, it is not restricted to the latter but rather can be multifariously modified.

The invention can be used in embedded systems in mobile phones, personal digital assistants (PDAs), handhelds, smartphones or other devices etc. having processing devices, for example central processing units, digital signal processors, microcontroller units, DMA data transmission devices, and internal and external memories. The operating systems used in this case may be any type of operating system and, in particular, operating systems for embedded systems, for example Symbian or WinCE, or operating systems having a known source code, for example Linux.

While the foregoing is directed to embodiments of the present invention, other and further embodiments of the invention may be devised without departing from the basic scope thereof, and the scope thereof is determined by the claims that follow.

What is claimed is:

1. A memory controller for controlling access to a plurality of memory devices by one or more processing devices, comprising:
one or more ports allowing the one or more processing devices to read data from or write data to the plurality of memory devices; and
a control component programmable via one or more of the processing devices to move data from a first location in the plurality of memory devices to a second location in the plurality of memory devices without transferring the data to the one or more processing devices.

2. The memory controller of claim 1, further comprising:
an arbitration component to selectively provide access to one of at least two processing devices; and
wherein the control component is programmable via a control signal generated by the arbitration component.

3. The memory controller of claim 1, wherein the control component is programmable to move data according to rules within a control program.

4. The memory controller of claim 3, wherein the processing component moves data according to one or more of the rules based on a control signal generated by one or more of the processing devices.

5. The memory controller of claim 1, wherein movements of data by the control component are interrupted by a control signal provided by one or more of the memory devices.

6. The memory device of claim 5, wherein the control signal provided by one or more of the memory devices indicates an asynchronous event has occurred.

7. An apparatus for controlling access by processing devices to memory devices in an embedded system, comprising:
a security device for protecting against access violations when the memories are being accessed by the processing devices;
a control component for moving data between different locations in the memory devices independently of the processing devices; and
a programmable interface allowing the control component to be programmed to control the manner in which the movement of data between different locations in the memory devices occurs.

8. The apparatus of claim 7, wherein the control component is controlled using a control program that configures the control component via the programmable interface.

9. The apparatus of claim 7, wherein the control component initiates movement of data in response to an externally supplied initialization signal.

10. The apparatus of claim 7, wherein the control component generates a notification signal to inform the embedded system that data has been moved.

11. An embedded system, comprising:
a plurality of memory devices;
a plurality of processing devices; and
a memory controller for controlling access to a plurality of memory devices by one or more processing devices, wherein the memory controller comprises a control component programmable via one or more of the processing devices to move data from a first location in the plurality of memory devices to a second location in the plurality of memory devices without transferring the data to the one or more processing devices.

12. The embedded system of claim 11, wherein:
the memory controller further comprises an arbitration component to selectively provide access to one of at least two processing devices; and
the control component is programmable via a control signal generated by the arbitration component.

13. The embedded system of claim 11, wherein the control component is programmable to move data according to rules within a control program.

14. The embedded system of claim 13, wherein the processing component moves data according to one or more of the rules based on a control signal generated by one or more of the processing devices.

15. The embedded system of claim 11, wherein movements of data by the control component are interrupted by a control signal provided by one or more of the memory devices.

16. The embedded system of claim 15, wherein the control signal provided by one or more of the memory devices indicates an asynchronous event has occurred.

17. A method of moving data between locations of a plurality of memory in an embedded system, comprising:
programming, via control signals generated by one or more processing devices of the embeded system, a control component of the memory controller; and
moving, by the control component, the data between the locations without transferring the data to the processing devices.

18. The method of claim 17, further comprising generating, by the control component a notification signal to indicate data has been moved.

19. The method of claim 17, wherein the programming comprises indicating one or more of a set of rules for the control component to apply when moving data.

20. An apparatus for controlling access by processing means to storage means in an embedded system, comprising:
control means for moving data between different locations in the storage means without transferring the data into the processing means; and
programmable interface means allowing the control means to be programmed to control the manner in which the movement of data between different locations in the storage means occurs.

21. The apparatus of claim 20, further comprising security means for protecting against access violations when the storage means are being accessed by the processing means.

22. The apparatus of claim 20, wherein the control means is controlled using a control program that configures the control component via the programmable interface means.

23. The apparatus of claim 20, wherein the control means initiates movement of data in response to an externally supplied initialization signal.

24. The apparatus of claim 20, wherein the control means generates a notification signal to inform the embedded system that data has been moved.
